(19) United States
(12) Patent Application Publication
(10) Pub. No.: US 2019/0390648 A1
(43) Pub. Date: Dec. 26, 2019

(54) WIND TURBINE WITH A VERTICAL ROTATION AXIS

(71) Applicant: Jan WISNIEWSKI, Modzelewskiego (PL)

(72) Inventor: Jan WISNIEWSKI, Modzelewskiego (PL)

(21) Appl. No.: 16/334,754

(22) PCT Filed: Sep. 19, 2017
(86) PCT No.: PCT/PL2017/000086

§ 371 Date: Mar. 20, 2019

(30) Foreign Application Priority Data
Sep. 23, 2016 (PL) P.418806

(51) Int. Cl. F03D 3/00; F03D 3/02; F03D 3/06

(52) U.S. Cl. CPC F03D 3/005; F05B 2240/214; F03D 3/061; F03D 3/02

(57) ABSTRACT

Turbine consists of several assemblies /2, 4/ of wings /3, 5/ of different length depending on the level of their placement, with the assemblies located higher /4/ having shorter length /l/ of the wings /5/compared to the length /L/ of the wings of the lower assembly /3/. The length /l/ of the wings /5/ of the higher assembly /4/ is from 0.15 to 0.85 of the length /L/ of the wings /3/ of the lower assembly /2/. The tips of the wings /3, 5/ of the subsequent assemblies overlap to 0.15 of the length /L/ of the wings /3/ of the lower assembly /2/.

In another version the wing tips /3, 5/ of the successive assemblies are spaced apart by a distance of not less than 0.02 and not more than 0.4 of the length /L/ of the lower assembly /2/.

The presented invention relates to a wind turbine with a vertical rotation axis of the main shaft.

Such turbines usually have one or more wing assemblies located on the main vertical shaft of the power station, shifted relative to each other by a fixed or changing angle.

“Vertical axis wind turbine wing and its wind rotor” described in the patent US 20120201687 A1 is a single-level wind turbine, characterized by the fact that the cross sections of its wings are aerodynamic profiles and that the wings are curved in such a way that there is an angular deviation between the upper and the lower end of each wing.

Another solution described in the patent UK 2463957-A, “Multiple rotor vertical axis wind turbine”, refers to a structure with a large number of generators to which a number of independent rotors are connected, each moving separately from each other.

The solution included in the Polish patent application No. PL 396608 “Wind turbine with vertical axis of rotation with rotor divided into independently moving segments” refers to a multi-level wind turbine characterized by the fact that its individual rotors are moving separately from each other and are not shifted by a fixed angle during work—their speed and position are continuously controlled by control systems. The application was rejected due to similarities to application No. UK 2463957-A.

The application No. WO 2016/030821 A1, “Three-vane double rotor for vertical axis wind turbine”, refers to a three-wing, drag-type double rotor wind turbine characterized by a 100% blockage ratio, with parts separated by a horizontal plate and each part being of the same height, and the application No. WO 2013/046011 A2 “Turbine for the production of electric energy”, refers to a gas or liquid drag-type turbine, consisting of shafts divided by horizontal plates fitted with curved tiles that change their angle of deviation with respect to shafts and that are consistent in height.

Today, all industrial wind turbines are horizontal axis wind turbines (HAWT). The attempts to produce a large-scale vertical axis wind turbine (VAWT) which is often presented as a cheaper, more effective alternative with additional pro-social benefits so far have not been successful due to significant problems such as the upper values of the bending moments during the operating cycle of the vertical axis wind turbine and the amplitude of these values translating into a decrease in the service life of the structure due to the fatigue of its critical components.

Both phenomena lead to a significant reduction in the durability of the power station, which is manifested by very rapid damage to its foundation or damage to the structure, which results in decisions on the lack of economic justification for erecting objects with such a limited lifespan, despite their numerous advantages. Sometimes, this problem is solved in part by creating a massive structure to increase the strength of the structure, but this process, on an industrial scale, is insufficient for the planned operating life of the plant and, at the same time, costly due to the increase in the materials required.

According to the invention, the wind turbine is characterized by the wings of the individual power units differentiating in length depending on the level of their placement. The wing assemblies located above have shorter wing lengths than the wing lengths of the lower assembly. The wing lengths of each of the assemblies located above are from 0.15 to 0.85 of the wing length of the lower assembly, preferably 0.4 to 0.6 of the wing length of the lower assembly.

According to the invention, the wind turbine preferably has wing tips of the successive assemblies overlapping at up to 0.25 of the “L” length of the wings of the lower assembly, preferably up to 0.05 of the “L” length of the wings of the lower assembly.

In another embodiment, the wind turbine has wing tips of further assemblies distant from each other with a distance not exceeding 0.35 of the “L” length of the wings of the lower assembly, preferably not greater than 0.15 of the “L” length of the wings of the lower assembly.

The technology of large-scale, multi-level wind turbine solves the problem of short lifespan by the proper construction of the rotor divided into assemblies shifted in phase in relation to each other with specific ratios relative to each other. The proposed solution limits the upper values of the torque at the base while also significantly reducing the loading amplitude. At the same time, the actions taken can result in a lighter construction, which both allows to reduce material costs and performs an aerodynamic function—the parameters, including the size of wings can be adjusted so as not to block the flow of air to an extent greater than necessary and allow for high aerodynamic performance.

The term “wind turbine” is used to describe wind power stations designed to operate at a linear speed of movement of the wings which is higher than the speed of the incoming undistorted wind in order to distinguish them from the drag-type wind power stations such as the Savonius windmill.

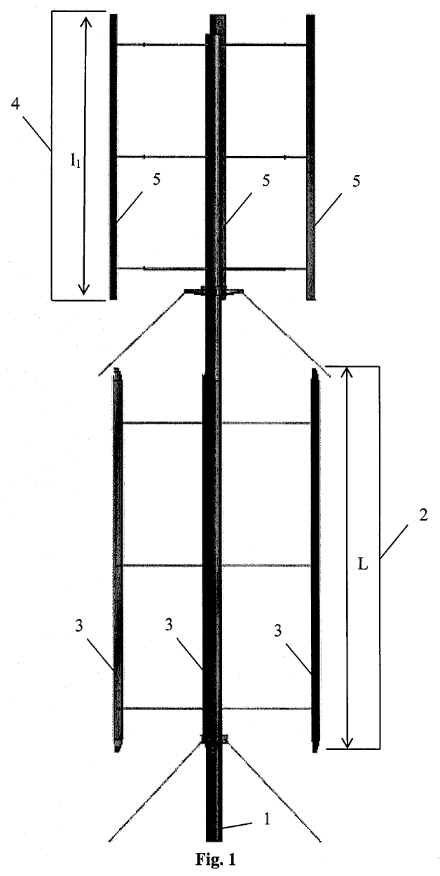

The wind turbine in its exemplary embodiment is shown in FIG. 1 presenting a front view of the wind turbine with two wing assemblies,

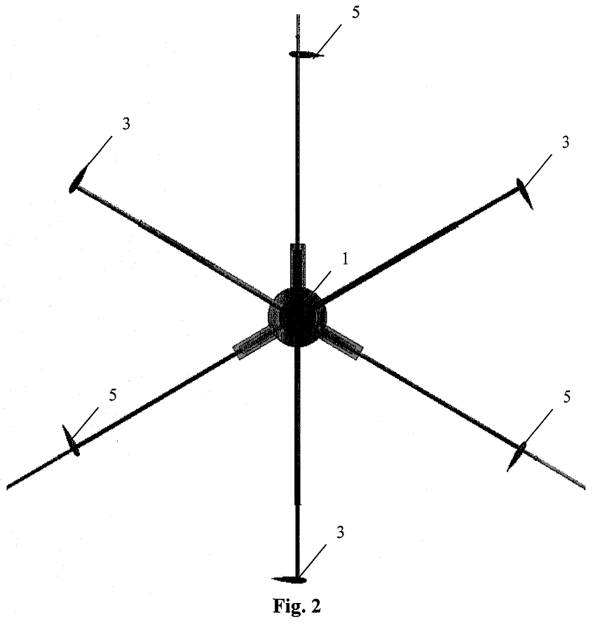

FIG. 2 presenting a top view of the turbine from FIG. 1, and

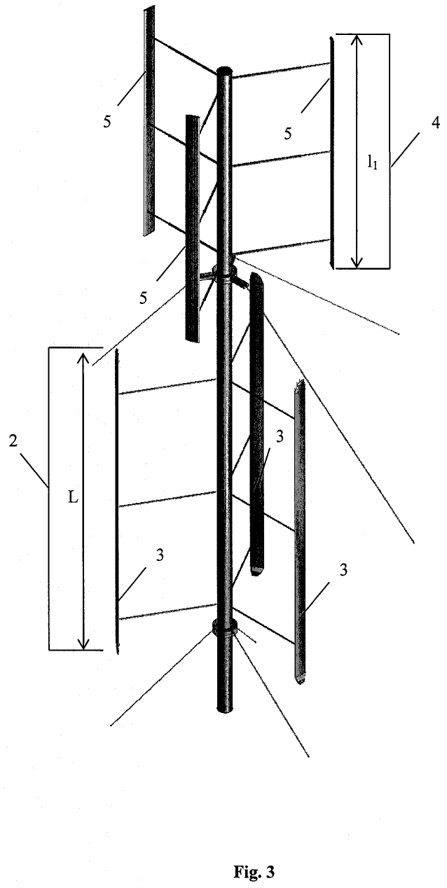

FIG. 3 presenting an isometric view of the turbine from FIG. 1.

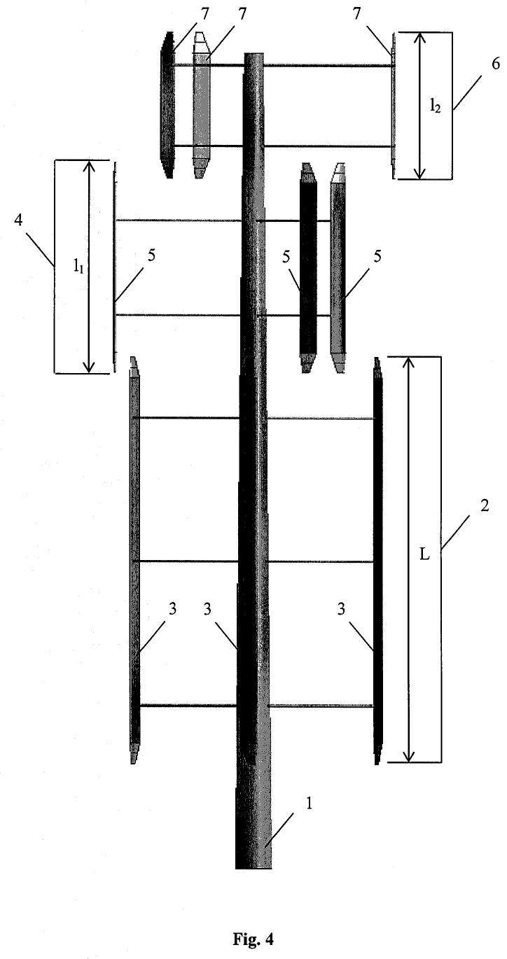

FIG. 4 shows a front view of the wind turbine with three wing assemblies;

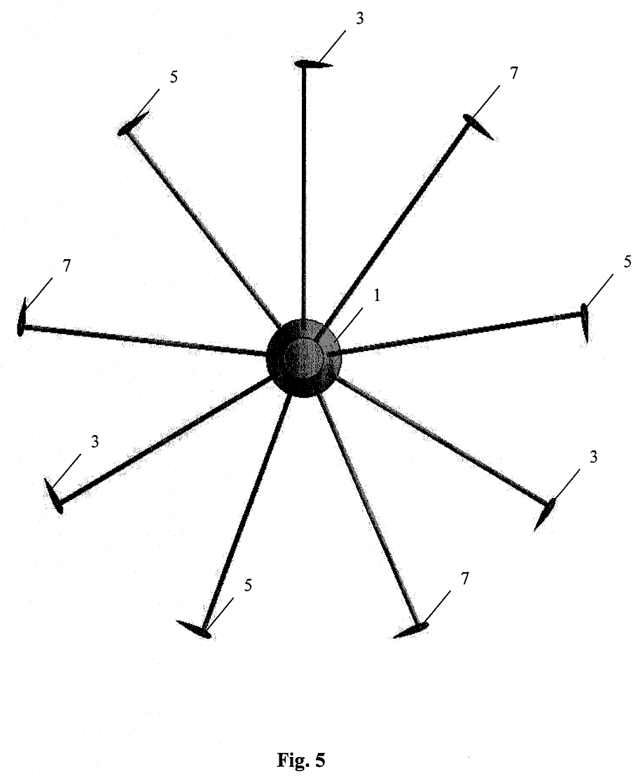

FIG. 5 is a top view of the wind turbine from FIG. 4 and

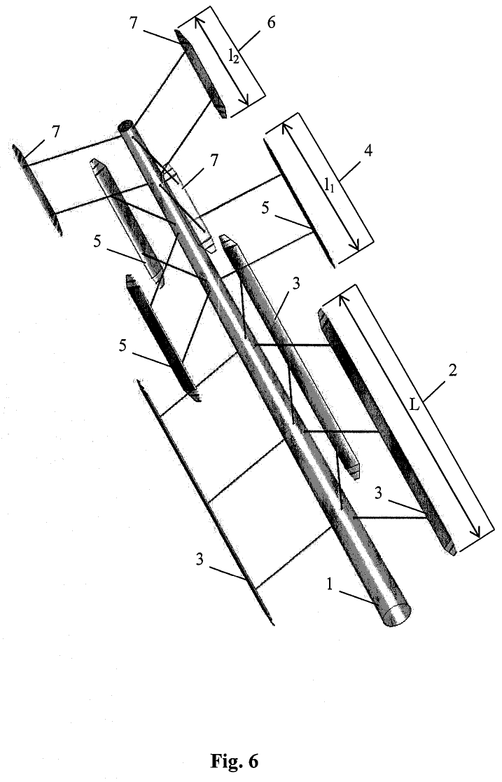

FIG. 6 shows an isometric view of the turbine from FIG. 4.

As shown in FIG. 1, the turbine has two wing assemblies on the main shaft 1, the first wing assembly 2 with three wings 3 and a second wing assembly 4 with three wings 5. The wings 5 of the second assembly 4 are shifted in phase relative to the wings 3 of the first assembly 2 by a fixed angle of 60 degrees. The wings 5 of the second assembly 4 have the length “l1” of 0.745 of the “L” length of the wings 3 of the first unit 2. The wing tips 5 of the second unit 4 are spaced by 0.213 of the “L” length from the wings 3 of the first assembly 2.

FIG. 4 shows a turbine analogous to the turbine shown in FIG. 1, however, it has three wing assemblies on the main shaft 1 of the turbine. The first assembly 2 with three wings 3 precedes the second assembly 4 with three wings 5 shifted in relation to the wings 3 in phase with a constant angle of 39 degrees. The next, third assembly 6 of the wings 7 is shifted relative to the second assembly 4 with three wings 5 in a shifted azimuthally with a fixed angle of 45 degrees. The wings 5 of the second assembly 4 have a “l1” length of 0.519 of the “L” length of the wings 3 of the first assembly 2. The wings 7 of the third assembly 6 have a length “l2” which is 0.358 of the “L” length of the wings 3 of the first assembly 2. Subsequent wing assemblies 2, 4 and 6 overlap themselves by 0.(037) of the length “L” of the wings 3 of the first assembly 2.

The operation of the system relies on the adjustment of the length of individual assemblies of the rotor and the shift between the wind turbine assemblies by a constant angular value, in such a way that the maximum values in the cycle of the bending moments at the base from the lower wind turbine rotor assembly would not add up to the maximum values of the bending moments at the base in a cycle from the remaining rotor units but that the distributions of the bending moments from the individual assemblies would converge with each other in time to maximally limit the maximum values of the bending moments at the base from the entire rotor and the range of the bending moments at the base. Achieving maximum limits of the above values requires adjusting the ratios of bending moments from individual assemblies through a series of procedures, the most important of which being the adjustment of the length of the assemblies. The optimum for a two-rotor assembly system is the variant for a wind turbine that is as close as possible to the values in the cycle, but the contributions of the individual assemblies in the total bending moment at the base of the cycle shifted in phase. For a three-level turbine with the approximate shape of the aerodynamic distribution of each assembly of the wind turbine, the ratio of the torque values shifted in the cycle at the base should be approximately 0.7:1:1.

What is claimed is:

1. A wind turbine with a vertical axis of rotation having more than one wing assembly located on the main shaft of the power station, shifted in phase by a fixed angle, characterized in that the wings /3, 5, 7/ of the individual units /2, 4, 6/ are of different lengths /L, l_{i=1,2,3 . . .} / depending on the level of their placement, while the assemblies located above /4, 6/ have shorter lengths /l_{i=1,2,3 . . .} / of their wings /5, 7/ than the length /L/ of the wings /3/ of the lower assembly /2/ and each of the lengths /l_{i=1,2,3 . . .} / of the wings /5, 7/ of the upper assemblies /4, 6/ is from 0.15 of the length /L/ of the wings /3/ of the lower assembly /2/ to 0.85 of the length /L/ of the wings /3/ of the lower assembly /2/, preferably from 0.4 to 0.6 of the length /L/ of the length /3/ of the lower assembly /2/.

2. The wind turbine according to claim 1, characterized in that the tips of the wings /3, 5, 7/ of the successive assemblies /2, 4, 6/overlap to 0.15 of the length /L/ of the wings /3/ of the lower assembly /2/.

3. The wind turbine according to claim 1, characterized in that the tips of the wings /3, 5, 7/ of the subsequent assemblies /2, 4, 6/ are spaced apart by a distance of not less than 0.02 and not more than 0.4 of the length /L/ of the wings /3/ of the lower assembly /2/, preferably from 0.05 to 0.2 of the length /L/ of the wings /3/ of the lower assembly /2/.
